(19) United States
(12) Patent Application Publication
(10) Pub. No.: US 2007/0074225 A1
(43) Pub. Date: Mar. 29, 2007

(54) Apparatus, method and computer program product providing integration environment having an integration control functionality coupled to an integration broker

(75) Inventors: Reijo Viertola, Helsinki (FI); Janne Veli Vuoti, Espoo (FI); Sami Petteri Tahtinen, Vantaa (FI)

Correspondence Address: HARRINGTON & SMITH, PC, 4 RESEARCH DRIVE, SHELTON, CT, 06484-6212, US

(73) Assignee: FRENDS Technology Inc.

(21) Appl. No.: 11/524,540

(22) Filed: Sep. 20, 2006

Related U.S. Application Data
(60) Provisional application No. 60/719,908, filed on Sep. 22, 2005.

(51) Int. Cl. G06F 9/46

(52) U.S. Cl. 719/313

(57) ABSTRACT

An integration control unit includes at least one user interface; a scheduling module to schedule a time to trigger initiation of an integration process; a triggering module to define at least one additional trigger condition to initiate the integration process and a connection point unit coupled to the user interface, the scheduling module and to the triggering module operable to produce connection point and connection point group definitions and control for integration endpoints.

### CLAIM OF PRIORITY FROM COPENDING PROVISIONAL PATENT APPLICATION

This patent application claims priority under 35 U.S.C. 119(e) from Provisional Patent Application No. 60/719,908, filed Sep. 22, 2005.

### TECHNICAL FIELD

The exemplary and non-limiting embodiments of this invention relate generally to data processing systems, methods and computer program products and, more specifically, relate to the sending of data between components of networked components, such as in an enterprise data processing environment.

### BACKGROUND

In an enterprise environment there are typically a number of enterprise applications as well as other software components (e.g., Point of Sale (POS) systems in a retail environment) that need to exchange data between one another. The data exchange can be done manually, but in most situations an automatic data exchange procedure is preferred so as to reduce manual effort and improve accuracy. For this purpose there exist a number of integration platforms (e.g., Microsoft BizTalk™ and BEA WebLogic Integrator™) that can exchange data automatically.

However, many currently available integration solutions are based on message brokers. A message broker is a component that is activated after receiving a message that originates external to the message broker, and that executes a defined integration task (typically involving communication with enterprise applications and other software, as well as transforming messages between these applications) only after the external message has arrived. In many cases, however, this approach is not optimum, as it requires that there is an active external software that knows that it needs to fetch the data from outside the message broker. However, this is not always the case.

For example, take a situation where there are a number of legacy systems that are not originally designed to exchange data between one another. Assume that there is some way to integrate these applications (i.e., a way to import and export data), but that none of these application actively trigger these integration tasks. Thus, it becomes necessary to have an external software component that has knowledge of when the integration functionality should be triggered. In a most elementary case the external application will trigger the data exchange between passive enterprise applications during a specific time window. However, in many real-world situations the triggering of the integration functionality can be more complex, where a single trigger criterion (e.g., time of day) is not adequate.

Thus, a message broker-based approach to integration is not sufficient in many cases. Further, and assuming that the message broker functionality can be used to exchange data, there is no central point or location from where the integration execution can be controlled.

As there exist a large number of message broker-based integration software applications, there is a need for a component that can control the integration functionality of these brokers. Prior to this invention, this need was not adequately met.

It is noted that the concept of a connection point has been mentioned or discussed in at least the following works: Veli-Pekka Kihnia: “Sovellusintegraatio-ohjelmisto verkkoliiketoiminnan arkkitehtuurina” (“Application integration software as an architecture of e-business”), a master's thesis for Helsinki University of Technology, 2003. http://users.tkk.fi/˜vkihnia/dtyo/diplomityo.pdf; and Ari Haapaniemi: “An EAI and ebXML-based Approach to Business-to-Business Integration”, master's thesis, Helsinki University of Technology, 2003.

### SUMMARY

The foregoing and other problems are overcome by the use of the exemplary embodiments of this invention.

In one aspect thereof the exemplary embodiments of this invention provide an integration control unit that includes at least one user interface; a scheduling module to schedule a time to trigger initiation of an integration process; a triggering module to define at least one additional trigger condition to initiate the integration process and a connection point unit coupled to the user interface, the scheduling module and to the triggering module operable to produce connection point and connection point group definitions and control for integration endpoints.

In another aspect thereof the exemplary embodiments of this invention provide a method to control an integration process. The method comprises operating a user interface for scheduling a time to trigger initiation of an integration process and for defining at least one additional trigger condition to initiate the integration process; and producing connection point and connection point group definitions for integration endpoints.

In a still further aspect thereof the exemplary embodiments of this invention provide a computer program product embodied on a computer readable medium that when executed by a data processor controls an integration process by operations that comprise operating a user interface for scheduling a time to trigger initiation of an integration process and for defining at least one additional trigger condition to initiate the integration process; and producing connection point and connection point group definitions for integration endpoints.

### BRIEF DESCRIPTION OF THE DRAWINGS

In the attached Drawing Figures:

FIG. 1 is a simplified clock diagram of a basic integration environment, wherein there is a need to exchange information between integrated systems within an enterprise as well as integration endpoints connected via some communication network.

FIG. 2 shows an exemplary screen shot of integration process definition using a conventional approach.

FIG. 3 illustrates an integration solution in accordance with exemplary embodiments of this invention that exhibits a centralized or concentrated control over the initiation of integration processes, and control over a distributed integration environment.

FIG. 4 is an exemplary screen shot that illustrates an example of schedule definition in accordance with a non-limiting embodiment of this invention.

FIG. 5 is a non-limiting example of trigger definition in accordance with a non-limiting embodiment of this invention.

FIG. 6 illustrates an exemplary embodiment of database relations for connection points.

FIG. 7 shows non-limiting examples of a user interface used for creating user interface forms for accessing connection point information in accordance with exemplary embodiments of this invention.

FIG. 8 illustrates an exemplary procedure that is used after a connection point category has been defined and the user interface has been created, to define connection points functions as an integral part of the integration controller.

FIG. 9 shows a non-limiting example of a manual grouping of connection points.

FIG. 10 illustrates two non-limiting examples of automatic (dynamic) connection point groups.

FIG. 11 depicts a logic flow diagram that is descriptive of the operation of the integration controller shown in FIG. 3.

### DETAILED DESCRIPTION

Environment

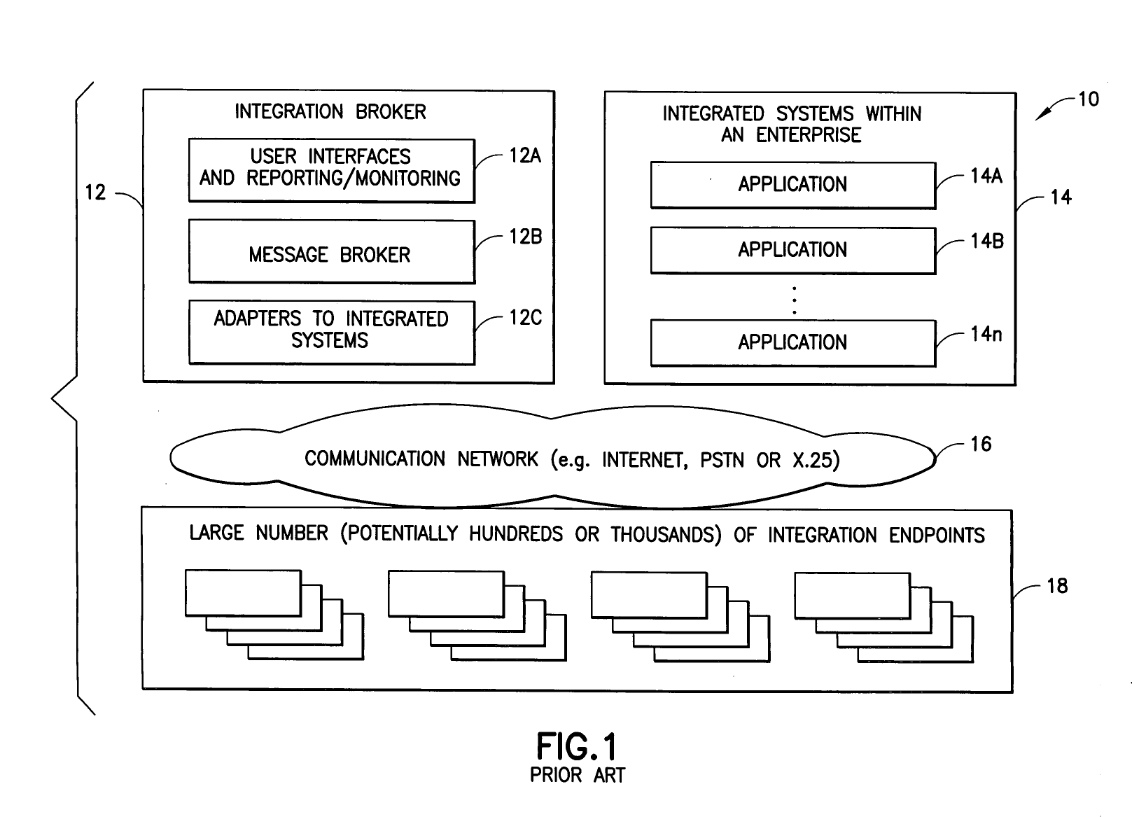

By way of introduction, FIG. 1 illustrates a basic and conventional integration environment 10 that includes an integration broker 12, a collection of integrated systems within an enterprise, shown generally as 14, that comprises a plurality of applications 14A, 14B, . . . , 14n, a communication network 16 (e.g., Internet, PSTN or X.25) and some potentially large number of integration endpoints 18. The integration broker 12 may include user interfaces 12A for reporting and monitoring purposes, a message broker 12B, and suitable adapters 12C to the integrated systems 14. It may be assumed that in the integration environment 10 there exists a need to exchange information between integrated systems 12 within an enterprise, as well as with the integration endpoints 18 connected via the communication network 16.

The basic environment of the integration solution shown in FIG. 1 includes message broker 12B-based integration software, the integrated applications 14A, 14B, . . . , 14n, and possibly a network of the integration endpoints 18 that have similar characteristics. As several non-limiting examples the integration endpoints 18 may be tens, hundreds or even thousands of POS applications, or Automatic Teller Machine (ATM) applications, or vending machine (applications).

The adapters 12C are typically software components capable of translating communication and data functionality of integrated systems into a form that data can be transferred between the message broker 12B and the integrated systems 14.

The integration broker 12 typically has no scheduling or triggering capabilities. Instead, the integration broker 12 can trigger integration processes if one of the integrated applications requests the integration functionality.

However, and particularly for a case where all the integrated applications are passive, then a need exists for the integration broker 12 to trigger the integration process automatically.

In the context of this description the terms “integration”, “integration solution” and “integration process” imply a procedure by which two or more different applications can automatically exchange data with one another. The two or more applications may be developed at different times, they may be based on different technologies (e.g., hardware, operating system, application server) and they may be developed, sold and maintained by different vendors. The integration solution task is to exchange data between different formats and applications and control the overall exchange of data, ideally in a transparent and seamless manner.

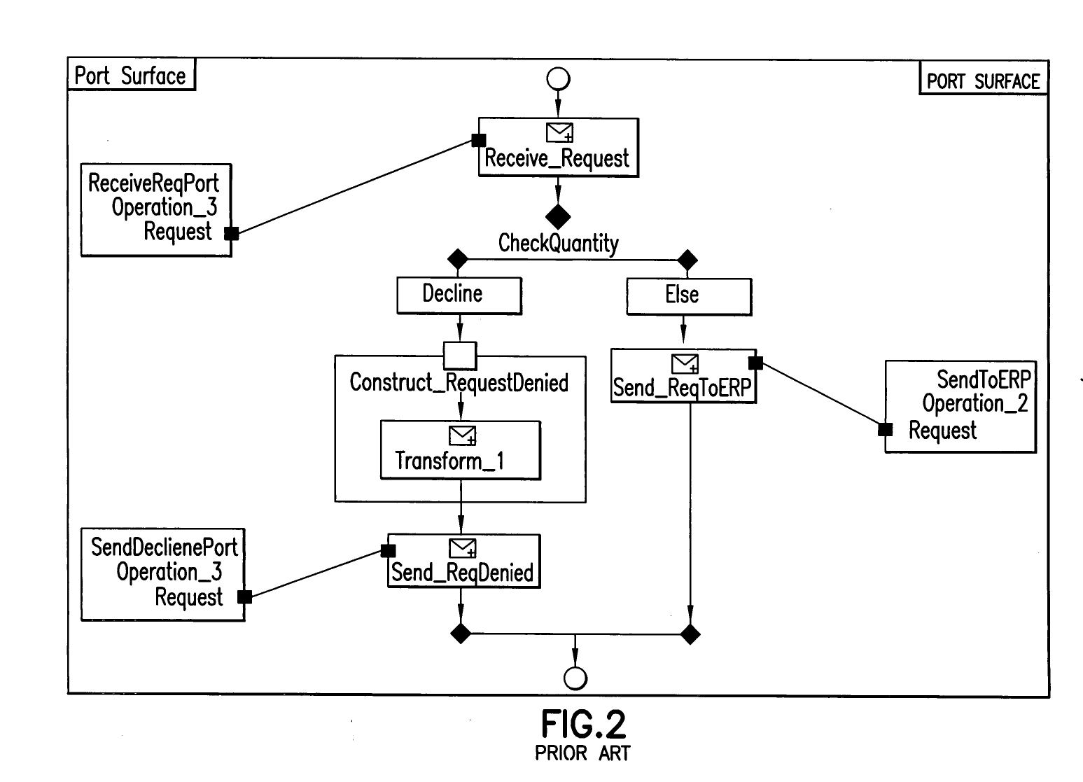

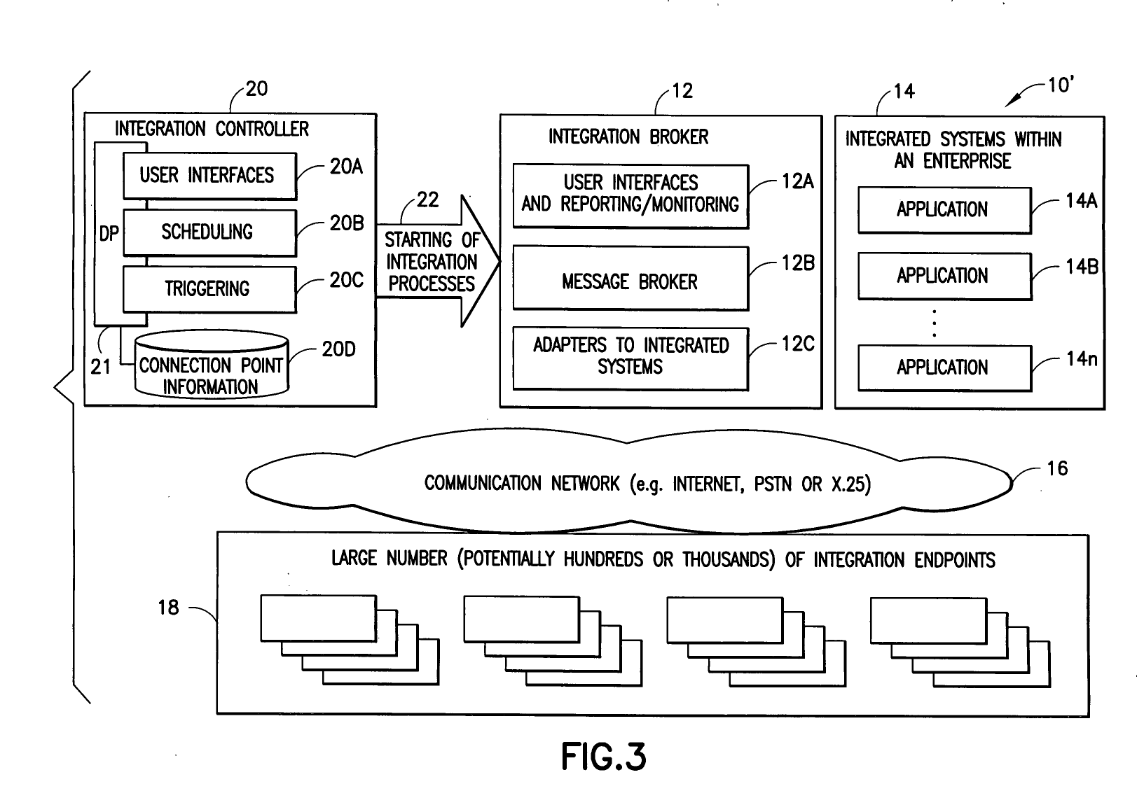

Thus, an integration process may be generally implied to mean a process of exchanging information between different applications. The integration process begins in response to some trigger (typically an incoming message) and it may require several steps. These steps may include transferring information between applications, transforming data between different formats, and deciding which steps should be taken and in which order. Integration processes are typically modeled graphically using orchestration tools. FIG. 2 is an example of a conventional process orchestration design as employed in a Microsoft BizTalk™ Server 2004.

It is noted that integration processes are sometimes referred to as “business processes”. However, in the context of this description the use of the phrase “integration processes” is preferred to emphasize that these processes are of technical nature.

FIG. 3 illustrates a basic environment of a presently preferred integration solution having scheduling and triggering capabilities, as well as control of a potentially large number of integration endpoints 18 in a distributed integration environment 10′.

In FIG. 3 there is shown an integration controller unit, or more simply an integration controller 20, that may be implemented in whole or in part as a software module stored in a computer readable medium for execution by at least one data processor 21. The integration controller 20 is used to achieve the desired functionality that is lacking in conventional integration broker/message broker-based systems. The integration controller unit 20 includes user interfaces 20A, scheduling 20B and triggering 20C modules, and further includes connection point and connection point group definition and controlling capabilities as discussed in greater detail below. Connection point-related information can be maintained in a data storage, such as in a database 20D.

Scheduling and Triggering

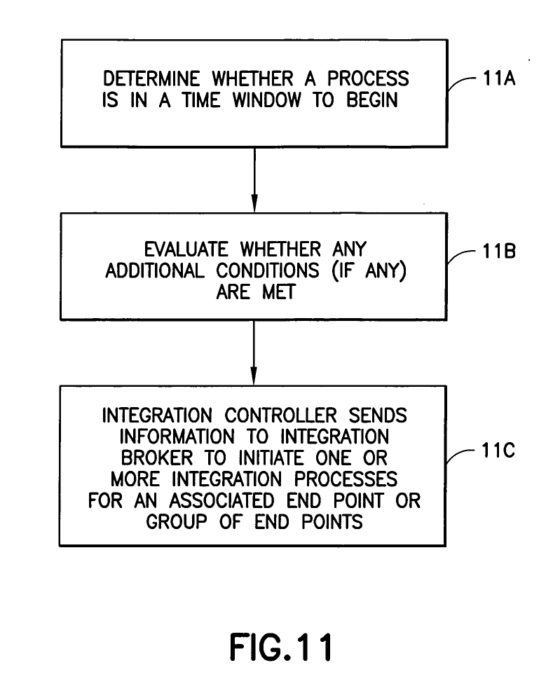

For an integration process to start correctly, the integration controller 20 includes a two-phase process to determine when the integration process should initiate a process. FIG. 11 depicts a logic flow diagram that is descriptive of the operation of the integration controller shown in FIG. 3. The procedure first determines whether a process is in a time window to begin (scheduling) (Block 11A), and then evaluates whether any additional conditions (if any) are met (Block 11B). Additional conditions may include, as non-limiting examples, an evaluation as to whether a specific file exists and/or if some certain data are correct. Various conditions may be combined to form more complex compound conditions. Assuming that all relevant conditions are met, the integration controller 20 sends information to the integration broker 12 to initiate one or more integration processes for an associated end point or group of end points 18 (Block 11C).

Schedules and triggers may be defined by an operator or a designer of a particular integration solution, although automatic or semi-automatic definition of one or more of schedules and triggers is also within the scope of the exemplary embodiments of this invention. Schedules contain information that is used to define a time window in which the integration process can start. As an example, a simple time window can be stated as “every day except Mondays, in a window starting at 1 A.M. and ending at 5 A.M.” A more complex schedule may contain several overlapping time windows; for example one time window starting “between 12:00 and 13:00 on every Monday” and another starting “first day of every month between 18:00 and 20:00”. The resulting schedule that contains these two windows is then active every Monday, and on first day of every month, whether the first day of the month is a Monday or not. Schedules are typically defined by the operator of the integration solution and the scheduling information is stored in the integration controller 20.

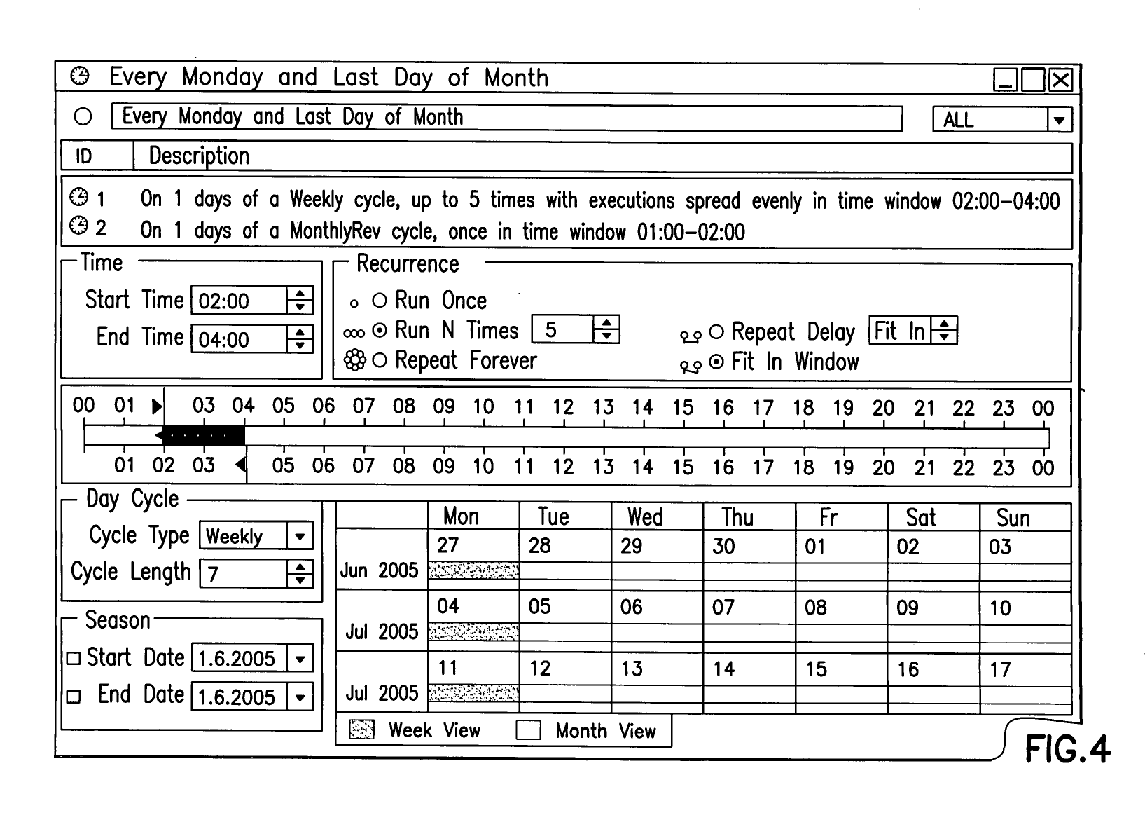

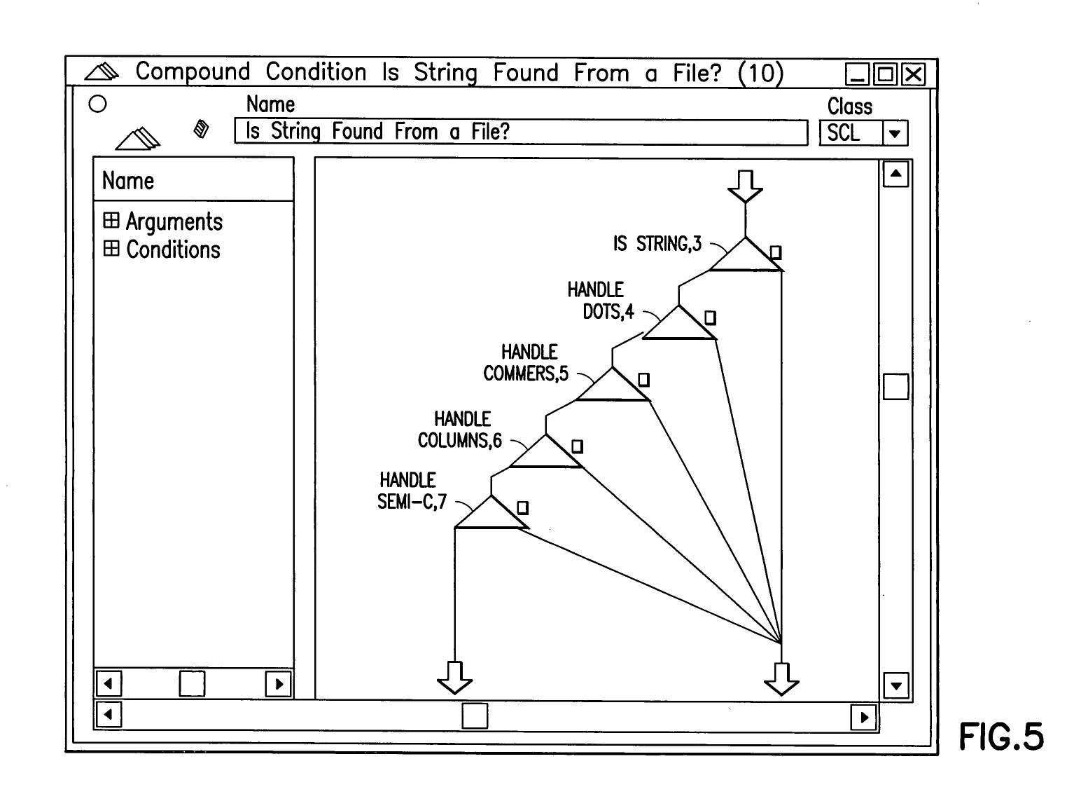

FIG. 4 demonstrates a non-limiting example of one of the user interfaces 20A that may be used for schedule definition. Here there is a description field where multiple descriptions (ids) of the scheduled items can be entered, controls for setting start and end times, controls for setting recurrence information (e.g., once, N times, repeat forever), as well as a cycle type, length and a calendar function.

When the integration controller 20 has determined that a specific integration process is within a scheduled time window (Block 11A of FIG. 11), it evaluates possible additional trigger conditions (Block 11B of FIG. 11). These trigger conditions may be defined using a graphical tool designed for evaluation of conditions; a non-limiting example of which is shown in FIG. 5 for a case: “is a string found in a file”. The triggers may be considered to be basically executable processes that return true/false values. They may be implemented as separate library methods or other executable code. The processes may include any number of sub-activities such as checking if a file contains a specific line. It is also within the scope of the exemplary embodiments of this invention to use pre-defined triggers within new triggers and, thus, trigger definitions may be hierarchical.

Triggers generated by the triggering module 20C are evaluated within the integration controller 20 context; and preferably do not have direct access to the integration capabilities of the integration broker 12. Because of this, it may not be (directly) possible to utilize information from integrated applications. However, this information can be brought to and considered by the integration controller 20. For example, the integration controller 20 may be parameterized to start a recurring integration process that brings information, e.g., from ERP using the integration capabilities of the integration broker 12.

This data may then be saved in a file or in a database where it can be accessed by the integration controller 20 during the execution of the trigger condition process.

After the integration controller 20 has evaluated that a specific integration process is within a specified time window and whether possible additional conditions are met, the integration controller 20 sends a message (shown generally as the arrow 22 in FIG. 3) to the integration broker 12 that initiates the actual integration process. After the integration process has been executed, the integration broker 12 can send a return message to the integration controller 20 so that the integration controller 20 always knows the status of the actual integration process: e.g., not started, started, completed successfully, completed with errors. This functionality provides an additional central point of control over the integration processes in a distributed integration environment.

However, it should be noted that the integration broker 12 may still execute integration processes that are requested by an integrated application. For example, in a situation where there is a portal or some other user interface whose functionality requires immediate execution of an integration process, this application can send a message to the integration broker 12, thereby effectively bypassing the integration controller 20. Thus, adding the integration controller 20 to an existing integration broker 12 enables adding scheduling and triggering functionality to the broker 12, without disturbing its original functionality.

Connection Points

In addition to the scheduling and triggering capabilities discussed above, the integration controller 20 provides functionality that improves management of integration endpoints in a distributed integration environment, such as one having a large number of connected applications (e.g. a retail chain with a number of POS systems). This is achieved with an object type referred to as a “connection point”.

Connection points are used to group together integration process parameters related to a single integration endpoint. This set of parameters is passed to the integration broker 12, which can then use the parameters for modifying the executed integration process. For example, if the integration process puts files to a number of FTP servers, the endpoint specific parameters such as server IP address, login user name and password, as non-limiting examples, may be gathered to separate connection points, allowing them to be easily passed together to the integration broker 12.

Defining Connection Point Templates

A connection point category is a template for a specific type of connection point. If there are a number of integration endpoints that differ from one another only by some parameters, these parameters are defined in a connection point category definition.

The connection point category may be considered to be analogous to a class in object-oriented programming. Once the category is defined, the user can define the actual connection points by giving values to the properties.

Connection points may be stored physically in structured storage such as an XML file or an underlying database, such as the database 20D shown in FIG. 3. All connection points have a unique ID, which can be used to reference them. For each connection point category, an XML document schema, database table, or some other media of storing information is created to store the information. These contain all required parameters for each connection point type as nodes or columns. There may also be a table of CPI_USED_TABLES that is used to bind actual data tables to the system.

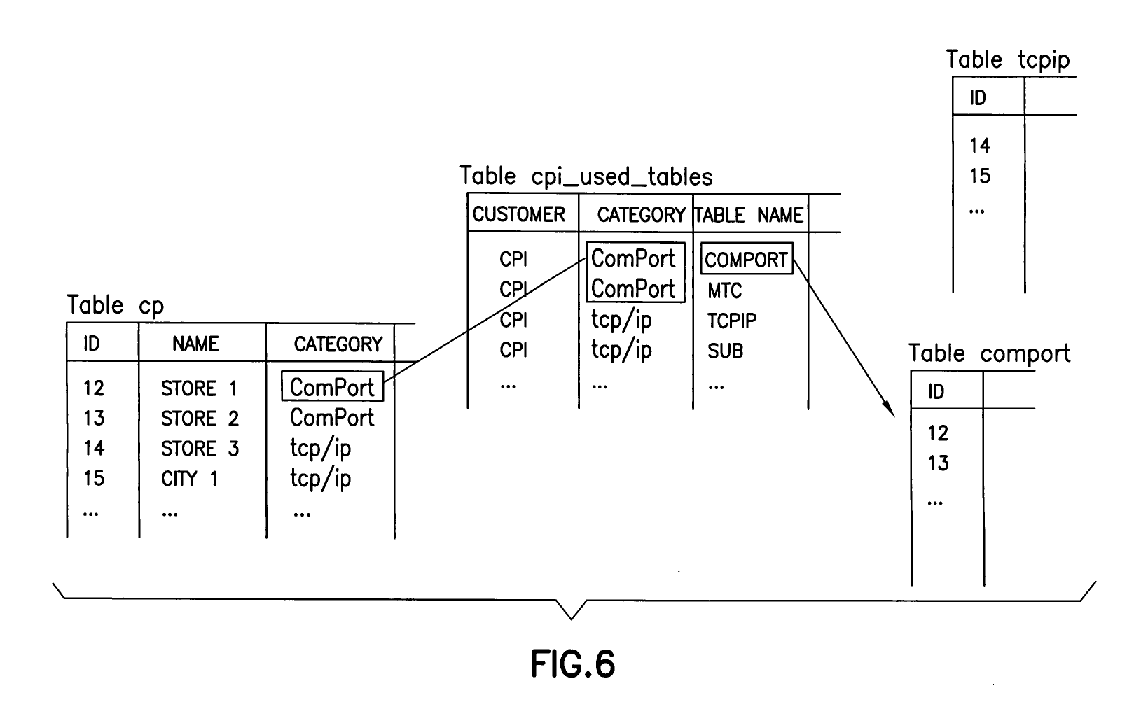

FIG. 6 shows a non-limiting example of database relations for connection points. CP and CPI_USED_TABLES may be present in the system, and the TCPIP and COMPORT tables in this example may be used to hold the actual data of connection points. It should be noted that the use of such tables is optional, and should not be construed as a limitation upon the implementation and practice of the exemplary embodiments of this invention.

Once the XML schema, database table or some similar structure that holds the information of a specific type of connection points is created, a user interface 20A form is created. This may be accomplished by using a drag-and-drop type of UI generation or user interfaces can be generated automatically.

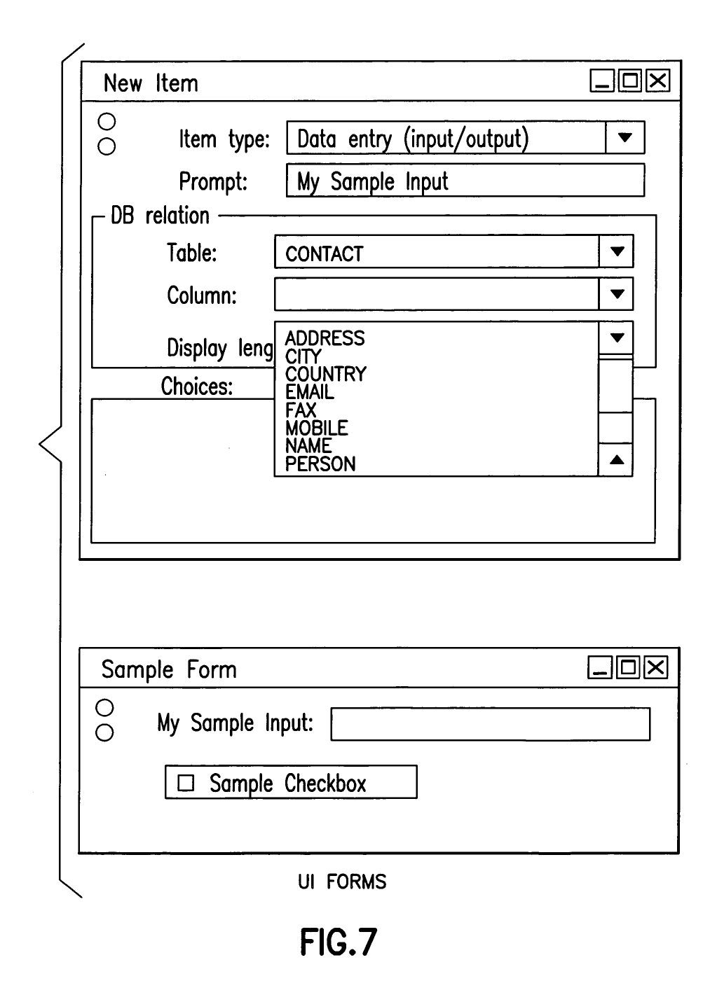

FIG. 7 shows non-limiting examples of a UI used for creating user interface forms for accessing connection point information. It should be noted that it is possible that this may be rewritten to allow Web-based design and usage of forms.

After the UI forms have been created, they may be automatically tied into the main user interfaces 20A of the integration controller 20, making it possible to create connection points using similar user interfaces.

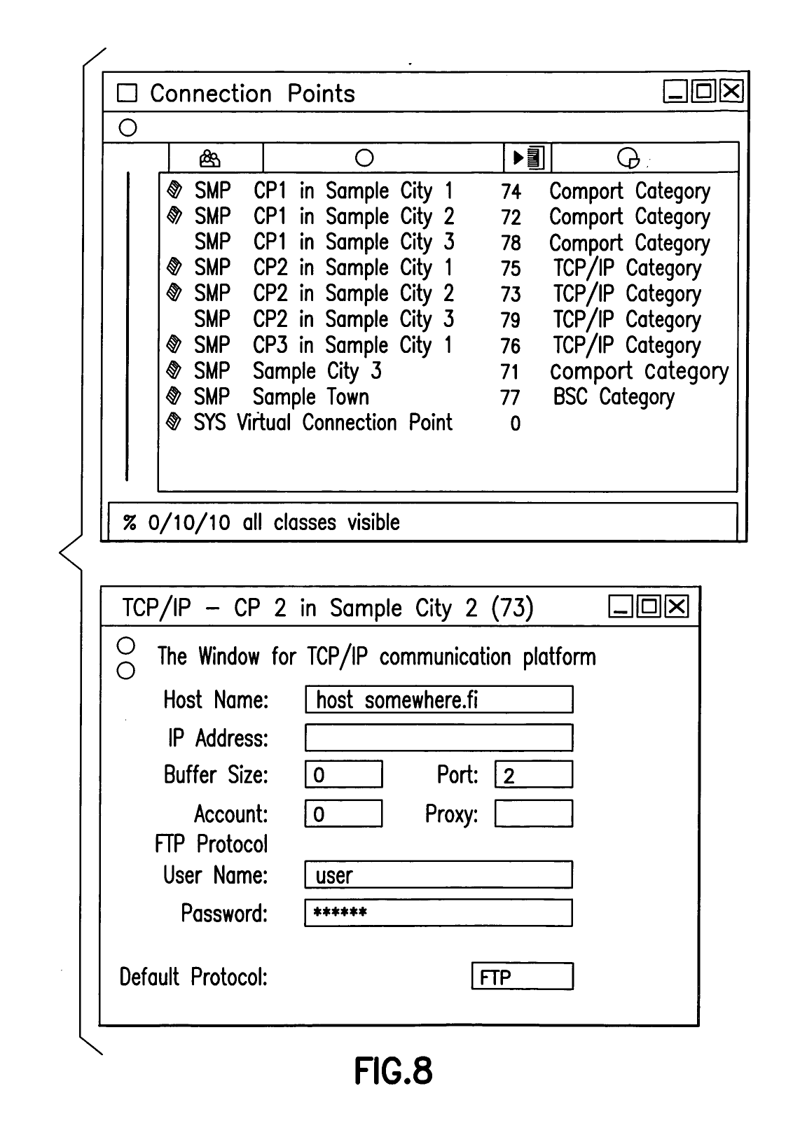

FIG. 8 shows that after a connection point category has been defined and the user interface has been created, the values for the connection point parameters can be set from the integration controller 20.

Grouping of Connection Points

A connection point may be used to store data about integration endpoints. However, without grouping functionality a connection point is only another place to store data that could be defined in the integration process (hosted by integration broker 12) itself. The power of connection points becomes more fully realized when they are grouped together. When a number of connection points are grouped together, a single quadruplet {schedule, trigger, connection point group, additional parameters} can control possibly hundreds or thousands of integration processes from a central definition. That is, instead of defining a large number of integration processes in the integration broker 12, the connection points are grouped together in the integration controller 20 and only a single quadruplet is then used to execute a large number of integration processes.

When the integration controller 20 decides to start an integration process that is directed to a connection point group, it sends one message to the integration broker 12 per each connection point. Each message contains all the data defined per connection point. For example, if a connection point category is defined to provide data for an FTP server, each message sent to the integration broker 12 includes the user ID, password, IP address, etc., of the specific FTP server.

The integration broker 12 executes an integration process instance for each of the messages it receives. As the message contains information of the connection point, the integration process can utilize this information. In the FTP connection point example, each triggered integration process can utilize the information contained in the message so that each process will connect to a specific FTP server.

There are at least two techniques to group the connection points into connection point groups; manual and automatic. In addition, groups can contain not only connection points but other groups, resulting in a hierarchical environment where integration can be directed to a group, its subgroup or an individual connection point.

Manual Grouping

In manual grouping a user defines which connection points or connection point groups are contained within the group. This can be useful in a relatively static environment, e.g., in a situation when the connection groups definition is based on geographical location of connection points. For example, there can be a group called “all servers in U.S.” that has a subgroup for each state. Each subgroup then contains servers within a particular state. Subsequently, then, each integration process can be directed to “all servers in U.S.”, “all servers in a State ______”, or to an individual server (without regard to location of the server).

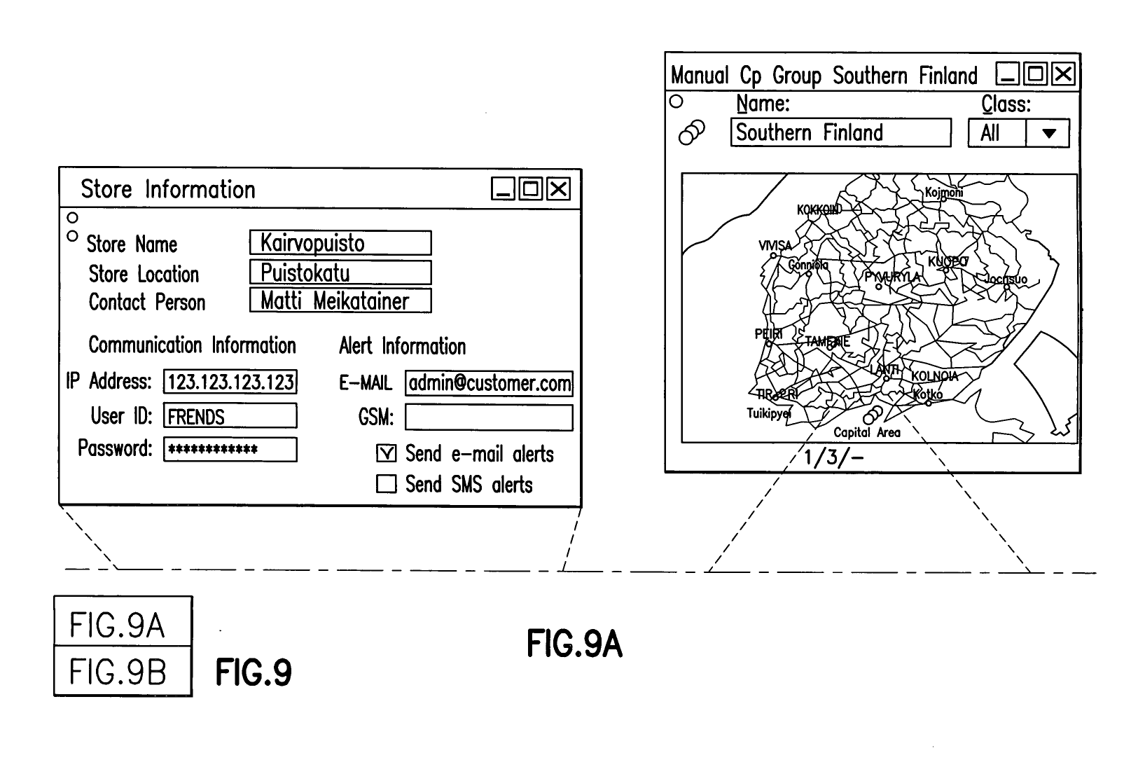

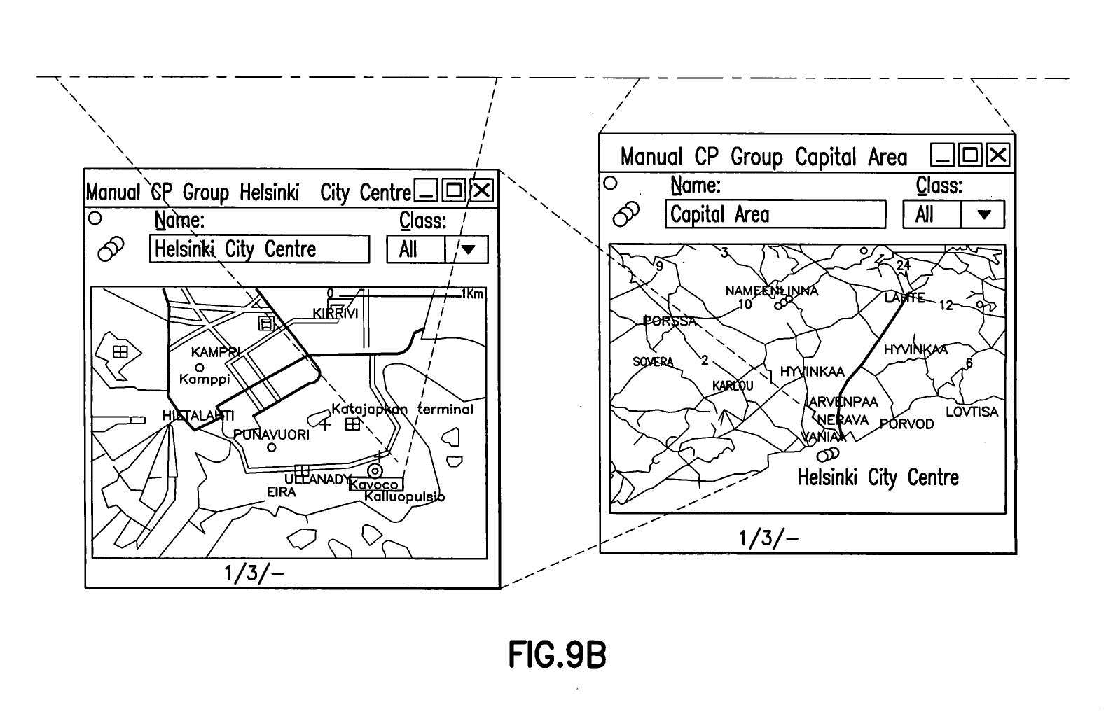

FIG. 9 depicts an examples of manual grouping of connection points. A “Store information” form is a user interface 20A component for a connection point template that provides information of a conceptual retail store (in this non-limiting embodiment).

Automatic Grouping

A second way to create connection point groups is to define groups dynamically. The actual content of the group is decided only after the integration controller 20 determines that a certain integration process should start, typically when both schedule and trigger conditions are met.

Automatic connection point group assignment can preferably occur at run-time and can be based on a structured query, such as an XPath query or a database query. The query may contain information such as “select all connection points where connection type is TCP/IP” or “select all connection points where e-mail used for alert information is defined”.

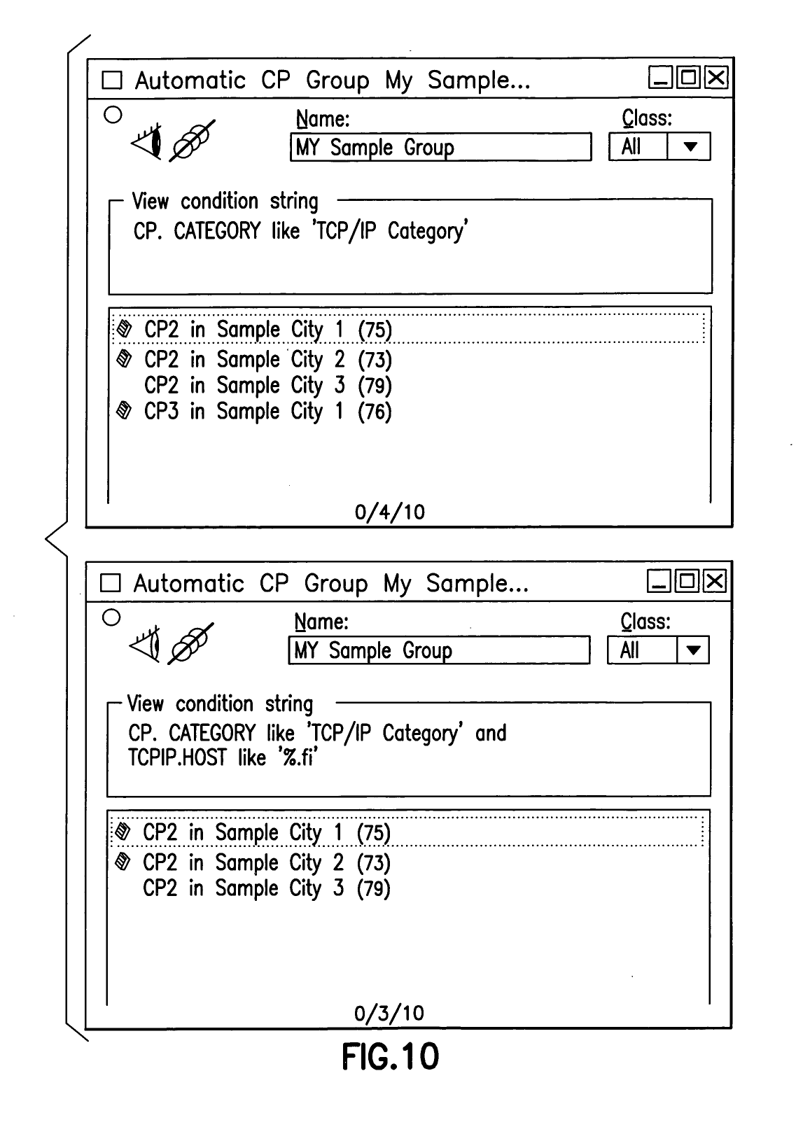

FIG. 10 illustrates two examples of automatic (dynamic) connection point groups. The upper one selects all connection points that belong to a connection point category defined as a “TCP/IP Category”. The lower one selects only those TCP/IP category connection points where the host (a parameter of a category) is located in a certain geographical region (e.g., Finland in this case). The TCP/IP table is the table where the actual data of the connection point is held.

Dynamic connection point groups are a powerful tool, for example, in a situation where there are dozens or hundreds of connection points already defined and tied into integration processes using dynamic groups. An operator need now just define a new connection point that is automatically tied into an automatic group based on the executed query, and the next time that an integration process is scheduled an integration process targeted to the new connection point is automatically executed.

Manual groups can contain automatic groups, but it is preferred that automatic groups do not contain other groups to reduce the possibility of cyclic references.

Relationship Between Control Objects

Objects defined above are combined into a quadruplet:

{schedule, trigger, (connection point|connection point group), parameters to the integration process}.

The schedule and trigger define when the integration process should start. The connection point or connection point group define information required for the integration process to execute processes for each connection point. Parameters to the integration process can include additional parameters that are not connection point specific. A non-limiting example includes an identification of the actual integration process that is executed by the integration broker 12. These parameters can also include other parameters, such as time-outs, that enable an operator to “fine-tune” the execution of integration processes. These additional parameters can overlap to some degree other functionality of the integration broker 12.

The integration controller 20 preferably provides the user interfaces 20A for defining, controlling and monitoring of each such quadruplet component, as well as the quadruplet itself.

Importing Positioning Data

As connection points can contain any data depending on the connection point template, they can also contain location or position information. When combined into a graphical presentation of the connection point groups, as shown in FIG. 9, user interfaces can provide information of the location of mobile integration endpoints, e.g., in a fleet management solution. On the other hand, when this information is presented to the integration broker 12, the broker 12 may utilize the data in an integration solution specific manner.

In a preferred embodiment of connection point grouping relationships to positioning data it becomes possible to combine geographical bitmaps (e.g., by integration to software such as Microsoft MapPoint™) to a dynamic grouping of connection points (based on location information).

As has been described above, integration solutions are typically considered as a way to exchange information between applications within an enterprise, hence the term EAI (Enterprise Application Integration). A more recent term, B2Bi (Business-to-business integration) addresses the need to exchange data between trading partners. However, in all of these situations a need to address a large number of structurally similar integration endpoints has not been taken into account. Connection points and their grouping in accordance with exemplary embodiments of this invention provide a technique to combine a large number of external integration endpoints to a solution that addresses also EAI and B2Bi needs.

The use of the connection points, combined with scheduling and triggering capabilities, create a much improved way to control integration solutions than that provided by a simple integration broker 12.

Various modifications and adaptations may become apparent to those skilled in the relevant arts in view of the foregoing description, when read in conjunction with the accompanying drawings.

In general it should be noted that the various exemplary embodiments of the invention described above may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. An integration control unit, comprising:
at least one user interface;
a scheduling module to schedule a time to trigger initiation of an integration process;
a triggering module to define at least one additional trigger condition to initiate the integration process; and
a connection point unit coupled to said user interface, said scheduling module and to said triggering module operable to produce connection point and connection point group definitions and control for integration endpoints.

2. The integration control unit of claim 1, further comprising data storage to store connection point-related information.

3. The integration control unit of claim 1, where said scheduling module is responsive to said user interface to define a time window during which the integration process can be initiated.

4. The integration control unit of claim 1, where said triggering module is responsive to said user interface to define at least one trigger definition.

5. The integration control unit of claim 4, where said at least one trigger definition is comprised of plural trigger definitions.

6. The integration control unit of claim 5, where said plural trigger definitions are hierarchical.

7. The integration control unit of claim 3, further comprising an output for coupling to an integration broker, where at least in response to a particular integration process being within the specified time window, and other trigger conditions, if any, being satisfied, the integration control unit outputs a message to the integration broker to initiate the particular integration process.

8. The integration control unit of claim 7, where the integration broker is also responsive to an input other than from the integration control unit to initiate an integration process.

9. The integration control unit of claim 1, where a connection point is used to group together integration process parameters related to a single integration endpoint.

10. The integration control unit of claim 9, further comprising an output for coupling to an integration broker, and where a set of integration process parameters is passed to the integration broker via the output for use when executing a related integration process.

11. The integration control unit of claim 1, where said connection point unit is responsive to said user interface to define a template for expressing a connection point category.

12. The integration control unit of claim 11, where the connection point category is used to define a connection point by assigning values to connection point category properties.

13. The integration control unit of claim 1, where each connection point has a unique identifier, and where connection points are stored in structured storage.

14. The integration control unit of claim 13, where the structured storage comprises an XML file.

15. The integration control unit of claim 13, where the structured storage comprises a database.

16. The integration control unit of claim 1, where said connection point unit is further responsive to said user interface to create user interface forms for at least one of accessing connection point information and assigning values to connection point parameters.

17. The integration control unit of claim 1, where said connection point unit is operable to manually group connection points together in response to information received from said user interface.

18. The integration control unit of claim 1, where said connection point unit is operable to automatically group connection points together after it is determined that a particular integration process should be initiated.

19. The integration control unit of claim 1, where said connection point unit is operable to group connection points together automatically in response to a structured query.

20. The integration control unit of claim 1, where a connection point group comprises at least one connection point and at least one group of connection points.

21. The integration control unit of claim 17, where a manually defined connection point group comprises at least one group of connection points that are automatically grouped together after it is determined that a particular integration process should be initiated.

22. The integration control unit of claim 1, where control over an integration process is achieved through use of a quadruplet {schedule, trigger, connection point, additional parameters}.

23. The integration control unit of claim 1, where control over a plurality of integration processes associated with a plurality of connection points is achieved through use of a quadruplet {schedule, trigger, connection point group, additional parameters}, where the connection point group defines members of a set of connection points.

24. The integration control unit of claim 11, where the connection point template comprises connection point location information.

25. The integration control unit of claim 24, where at least one connection point of a group of connection points is associated with a mobile integration endpoint.

26. The integration control unit of claim 24, where said connection point unit is operable to dynamically group connection points together based on the location information.

27. A method to control an integration process, comprising:
operating a user interface for scheduling a time to trigger initiation of an integration process and for defining at least one additional trigger condition to initiate the integration process; and
producing connection point and connection point group definitions for integration endpoints.

28. The method of claim 27, where scheduling defines a time window during which the integration process can be initiated.

29. The method of claim 27, where defining generates at least one trigger definition comprising one or more than one trigger definitions.

30. The method of claim 28, where the more than one trigger definitions are hierarchical.

31. The method of claim 28, further comprising in response to a particular integration process being within the specified time window, and other trigger conditions, if any, being satisfied, outputting a message to an integration broker to initiate the particular integration process.

32. The method of claim 27, where a connection point is used to group together integration process parameters related to a single integration endpoint.

33. The method of claim 32, further comprising passing a set of integration process parameters to an integration broker for use when executing a related integration process.

34. The method of claim 27, further in responsive to said user interface defining a template for expressing a connection point category.

35. The method of claim 34, where the connection point category is used to define a connection point by assigning values to connection point category properties.

36. The method of claim 27, where each connection point has a unique identifier, and where connection points are stored in structured storage.

37. The method of claim 36, where the structured storage comprises an XML file.

38. The method of claim 36, where the structured storage comprises a database.

39. The method of claim 27, further in response to the user interface creating user interface forms for at least one of accessing connection point information and assigning values to connection point parameters.

40. The method of claim 27, further comprising manually grouping connection points together in response to information received from said user interface.

41. The method of claim 27, further comprising automatically grouping connection points together in response to determining that a particular integration process should be initiated.

42. The method of claim 27, further comprising grouping connection points together automatically in response to a structured query.

43. The method of claim 27, where a connection point group comprises at least one connection point and at least one group of connection points.

44. The method of claim 40, where a manually defined connection point group comprises at least one group of connection points that are automatically grouped together after it is determined that a particular integration process should be initiated.

45. The method of claim 27, where control over an integration process is achieved through use of a quadruplet {schedule, trigger, connection point, additional parameters}.

46. The method of claim 27, where control over a plurality of integration processes associated with a plurality of connection points is achieved through use of a quadruplet {schedule, trigger, connection point group, additional parameters}, where the connection point group defines members of a set of connection points.

47. The method of claim 34, where the connection point template comprises connection point location information.

48. The method of claim 47, where at least one connection point of a group of connection points is associated with a mobile integration endpoint.

49. The method of claim 47, further comprising dynamically grouping connection points together based on the location information.

50. A computer program product embodied on a computer readable medium that when executed by a data processor controls an integration process by operations that comprise:
operating a user interface for scheduling a time to trigger initiation of an integration process and for defining at least one additional trigger condition to initiate the integration process; and
producing connection point and connection point group definitions for integration endpoints.

51. The computer program product of claim 50, where scheduling defines a time window during which the integration process can be initiated.

52. The computer program product of claim 50, where defining generates at least one trigger definition comprising one or more than one trigger definitions.

53. The computer program product of claim 52, where the more than one trigger definitions are hierarchical.

54. The computer program product of claim 52, further comprising in response to a particular integration process being within the specified time window, and other trigger conditions, if any, being satisfied, outputting a message to an integration broker to initiate the particular integration process.

55. The computer program product of claim 50, where a connection point is used to group together integration process parameters related to a single integration endpoint.

56. The computer program product of claim 55, further comprising passing a set of integration process parameters to an integration broker for use when executing a related integration process.

57. The computer program product of claim 50, further in responsive to said user interface defining a template for expressing a connection point category.

58. The computer program product of claim 57, where the connection point category is used to define a connection point by assigning values to connection point category properties.

59. The computer program product of claim 50, where each connection point has a unique identifier, and where connection points are stored in structured storage.

60. The computer program product of claim 59, where the structured storage comprises an XML file.

61. The computer program product of claim 59, where the structured storage comprises a database.

62. The computer program product of claim 50, further in response to the user interface creating user interface forms for at least one of accessing connection point information and assigning values to connection point parameters.

63. The computer program product of claim 50, further comprising manually grouping connection points together in response to information received from said user interface.

64. The computer program product of claim 50, further comprising automatically grouping connection points together in response to determining that a particular integration process should be initiated.

65. The computer program product of claim 50, further comprising grouping connection points together automatically in response to a structured query.

66. The computer program product of claim 50, where a connection point group comprises at least one connection point and at least one group of connection points.

67. The computer program product of claim 63, where a manually defined connection point group comprises at least one group of connection points that are automatically grouped together after it is determined that a particular integration process should be initiated.

68. The computer program product of claim 50, where control over an integration process is achieved through use of a quadruplet {schedule, trigger, connection point, additional parameters}.

69. The computer program product of claim 50, where control over a plurality of integration processes associated with a plurality of connection points is achieved through use of a quadruplet {schedule, trigger, connection point group, additional parameters}, where the connection point group defines members of a set of connection points.

70. The computer program product of claim 57, where the connection point template comprises connection point location information.

71. The computer program product of claim 70, where at least one connection point of a group of connection points is associated with a mobile integration endpoint.

72. The computer program product of claim 70, further comprising dynamically grouping connection points together based on the location information.
